(19) United States
(12) Patent Application Publication
(10) Pub. No.: US 2019/0039915 A1
(43) Pub. Date: Feb. 7, 2019

(54) ENVIRONMENTALLY FRIENDLY BALANCED WASTE WATER TREATMENT SYSTEM FOR DIVERSIFIED MEDICAL USE

(71) Applicant: Hiu Ching WONG, Hong Kong (HK)

(72) Inventor: Hiu Ching WONG, Hong Kong (HK)

(21) Appl. No.: 15/697,474

(22) Filed: Sep. 7, 2017

(30) Foreign Application Priority Data
Aug. 1, 2017 (CN) 201710647511.6

(51) Int. Cl. C02F 1/00; C02F 1/20; B01D 21/24; B01D 21/00; B01D 19/00

(52) U.S. Cl. CPC C02F 1/006; C02F 1/004; C02F 1/20; C02F 2001/007; B01D 21/0006; B01D 19/0031; B01D 21/24

(57) ABSTRACT

The present invention relates to an environmentally friendly balanced waste water treatment system for diversified medical use, comprises a conditioning tank, a cleaning solution tank, a gas separator, a waste water lifting pump, a beveled wall sedimentation pool and a membrane filter device. The conditioning tank is connected to an external washing cloth waste water pipe. The conditioning tank is connected to the air separator and the waste water lifting pump, an output end of the waste water lifting pump is connected to the beveled wall sedimentation pool. The water treatment system of the present invention can break down hazardous materials in the waste water, does not cause secondary pollution, provides a good cleaning effect for medical waste water, complying with water treatment standard. It provides improved practicality and advancement, operation is stable, does not occupy a lot of floor space, layout is reasonable, production efficiency is high, operating life is long, ensuring long trouble free operation time.

### FIELD OF INVENTION

The present invention relates to the field of waste water treatment equipment, in particular to an environmentally friendly balanced waste water treatment system for diversified medical use.

### BACKGROUND OF INVENTION

As economy grows, medical hygiene standard is improving, what follows is the problem regarding medical waste water treatment. If medical waste water is not treated properly, or is not monitored closely, many water sources will be polluted to different extents. However, the cost for medical waste water treatment is high, and existing technology does nor provide satisfactory treatment results, not easily meeting the state standard for waste water emission. Therefore, the existing technology has to be further developed and improved.

### SUMMARY OF INVENTION

The technical problem to be solved by the present invention is: to overcome the aforementioned problem, an environmentally friendly balanced waste water treatment system for diversified medical use is provided. The water treatment system can break down hazardous materials in the waste water, does not cause secondary pollution, provides a good cleaning effect for medical waste water, complying with water treatment standard.

The technical solution used in the present invention to solve the technical problem is: an environmentally friendly balanced waste water treatment system for diversified medical use, comprises a conditioning tank, a cleaning solution tank, a gas separator, a waste water lifting pump, a beveled wall sedimentation pool and a membrane filter device. The conditioning tank is connected to an external washing cloth waste water pipe. The conditioning tank is connected to the air separator and the waste water lifting pump through pipes, an output end of the waste water lifting pump is connected to the beveled wall sedimentation pool through pipes. An electromagnetic flow gauge is disposed at a pipe connected between the waste water lifting pump and the beveled wall sedimentation pool. A side wall of the beveled wall sedimentation pool is connected to the filter membrane device through pipes. A water pump is connected at the filter membrane device, the filter membrane device is connected to a clean water tank through the water pump. A sludge pump is connected to a bottom of the beveled wall sedimentation pool through pipes. A sludge tank is connected at an output end of the sludge pump. A cleaning solution lifting pump is connected at the cleaning solution tank, a cleaning solution dosing pump is connected to the cleaning solution lifting pump through pipes. The cleaning solution dosing pump is connected separately to the filter membrane device, the clean water tank and the air separator. The air separator is connected to plant area gas pipes, a pressure reduction valve is disposed on the plant area gas pipes. Another path of the air separator is connected to the filter membrane device through a vortex flow meter. A backflow pump is connected to a bottom end of the filter membrane device, the filter membrane device is connected to the sludge tank though the backflow pump. The sludge tank is connected to an additive trough through the sludge tank, the additive trough is connected to a sludge conditioning tank through a drug pump. The sludge conditioning trough is connected to a centrifugal dehydration machine.

In a preferred embodiment, a pressure difference level meter is disposed in the conditioning tank.

The membrane filter device comprises a filter tank and a filter device disposed inside the filter tank, the filter tank comprises an upper tank and a lower tank. The upper tank and the lower tank are locked together through flange mouths. A raw water opening is disposed at a top end of the upper tank for connecting to the beveled wall sedimentation pool. A single filter plate is connected between the upper tank and the lower tank. A number of fine pores and micropores are uniformly distributed on the single filter plate. The lower tank is divided into a backflow chamber and a filter chamber, the fine pores are connected to the backflow chamber, the micropores are connected to the filter chamber. A sludge outlet is disposed at a bottom of the backflow chamber connected to the backflow pump. A filtered water outlet is disposed at a side wall of the filter chamber connected to the water pump. The filter device comprises a tubular membrane component disposed inside the filtering chamber, the tubular membrane component comprises a membrane support plate horizontally fixed inside the filter chamber, a filter membrane module and a pressed plate, the membrane support plate is divided into four quarters, each quarter having at least two filter membrane insertion holes and at least two alignment lock holes, openings corresponding to filter membrane insertion holes and bolt holes corresponding to the alignment lock holes are opened at the pressed plate. The filter membrane module comprises a sub membrane support plate corresponding to a quarter of the membrane support plate, and at least two tubular membrane components vertically mounted on the sub membrane support plate. An opening of the tubular membrane component penetrates through a top surface of the sub membrane support plate. Through holes corresponding to the alignment lock holes are disposed on the sub membrane support plate. The pressed plate, the filter membrane module and the membrane support plate are locked to the alignment lock hole through the bolt hole and the through hole.

Mixers are disposed in the additive trough and the sludge conditioning trough. An ultrasonic level meter is disposed in the sludge conditioning trough.

A suspended beam is disposed inside the beveled wall sedimentation pool. A number of one sided beveled wall sheet is attached to the suspended beam, a number of beveled wall horizontal rod is disposed between adjacent suspended beams. A number of double sided beveled wall sheet is disposed on the beveled wall horizontal rod, a reinforced pipe is disposed inside a cavity of the beveled wall horizontal rod.

The advantage of the present invention is: using the filter membrane module of the present invention, the tubular membrane component can be replaced after filtering, therefore is quick and convenient. The water treatment system can break down hazardous materials in the waste water, does not cause secondary pollution, provides a good cleaning effect for medical waste water, complying with water treatment standard. It provides improved practicality and advancement, operation is stable, does not occupy a lot of floor space, layout is reasonable, production efficiency is high, operating life is long, ensuring long trouble free operation time.

### BRIEF DESCRIPTION OF DRAWINGS

The present invention is further explained below with the accompanying drawings and embodiments.

FIG. 1 is an overall structural schematic diagram of an environmentally friendly balanced waste water treatment system for diversified medical use according to the present invention.

FIG. 2 is a structural schematic diagram of a membrane filter device of FIG. 1.

FIG. 3 is a structural schematic diagram of a filter device of FIG. 2.

FIG. 4 is a structural schematic diagram of a beveled wall sedimentation pool of FIG. 1.

Reference numbers in the drawings: 1 conditioning tank, 2 cleaning solution tank, 3 air separator, 4 waste water lifting pump, 5 beveled wall sedimentation pool, 6 membrane filter device, 61 filter device, 62 upper tank, 621 raw water opening, 3 lower tank, 631 backflow chamber, 632 filter chamber, 633 sludge outlet, 634 filtered water exit, 64 single filter plate, 641 fine pore, 642 micropore, 65 tubular membrane component, 651 membrane support plate, 652 filter membrane module, 6521 sub membrane support plate, 6522 tubular membrane component, 6523 through hole, 653 pressed plate, 6531 opening, 6532 bolt hole, 654 filter membrane insertion hole, 655 alignment lock hole, 7 water pump, 8 clean water tank, 9 sludge pump, 10 sludge tank, 11 cleaning solution lifting pump, 12 cleaning solution dosing tank, 13 pressure reduction valve, 14 vortex flow gauge, 15 backflow pump, 16 additive trough, 17 sludge conditioning trough, 18 pressure difference level gauge, 19 electromagnetic flow gauge, 23 mixer, 24 ultrasonic level gauge, 25 suspended beam, 26 beveled wall horizontal rod, 27 double sided beveled wall sheet, 28 reinforced pipe, 29 single sided beveled wall sheet, 30 dosing pump.

### DETAILED DESCRIPTION OF INVENTION

The present invention is further explained below along with the accompanying drawings. The drawings are all simplified schematic diagrams which only illustrates the basic structure of the present invention, as such only the components material to the present invention are shown.

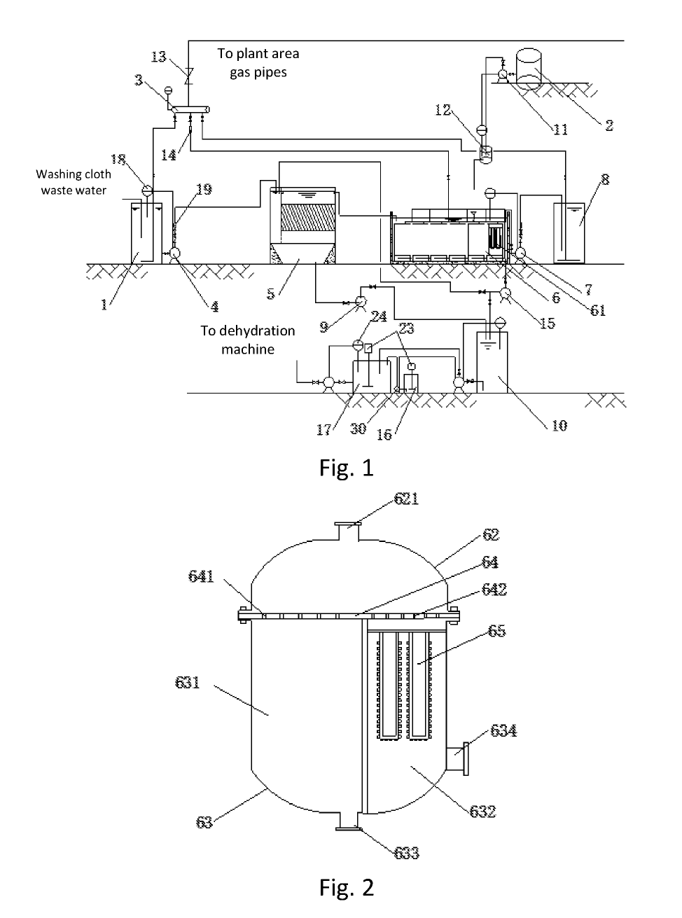

An environmentally friendly balanced waste water treatment system for diversified medical use is shown in FIG. 1. The water treatment system comprises a conditioning tank 1, a cleaning solution tank 2, a gas separator 3, a waste water lifting pump 4, a beveled wall sedimentation pool 5 and a membrane filter device 6. The conditioning tank 1 is connected to an external washing cloth waste water pipe. A pressure difference level meter 18 is disposed in the conditioning tank 1. The conditioning tank 1 is connected to the air separator 3 and the waste water lifting pump 4 through pipes, an electromagnetic flow gauge 19 is disposed at a pipe connected between the waste water lifting pump 4 and the beveled wall sedimentation pool 5. An output end of the waste water lifting pump 4 is connected to the beveled wall sedimentation pool 5 through pipes, a side wall of the beveled wall sedimentation pool 5 is connected to the filter membrane device 6 through pipes. A water pump 7 is connected at the filter membrane device 6, the filter membrane device 6 is connected to a clean water tank 8 through the water pump 7. A sludge pump 9 is connected to a bottom of the beveled wall sedimentation pool 5 through pipes. A sludge tank 10 is connected at an output end of the sludge pump 9. A cleaning solution lifting pump 11 is connected at the cleaning solution tank 2, a cleaning solution dosing pump 12 is connected to the cleaning solution lifting pump 11 through pipes. The cleaning solution dosing pump 12 is connected separately to the filter membrane device 6, the clean water tank 8 and the air separator 3. The air separator 3 is connected to plant area gas pipes, a pressure reduction valve 13 is disposed on the plant area gas pipes. Another path of the air separator 3 is connected to the filter membrane device 6 through a vortex flow meter 14. A backflow pump 15 is connected to a bottom end of the filter membrane device 6, the filter membrane device 6 is connected to the sludge tank 10 though the backflow pump 15. The sludge tank 10 is connected to an additive trough 16, the additive trough 16 is connected to a sludge conditioning tank 17 through pipes. Mixers 23 are disposed in the additive trough 16 and the sludge conditioning trough 17. An ultrasonic level meter 24 is disposed in the sludge conditioning trough 17, the sludge conditioning trough 17 is connected to a centrifugal dehydration machine.

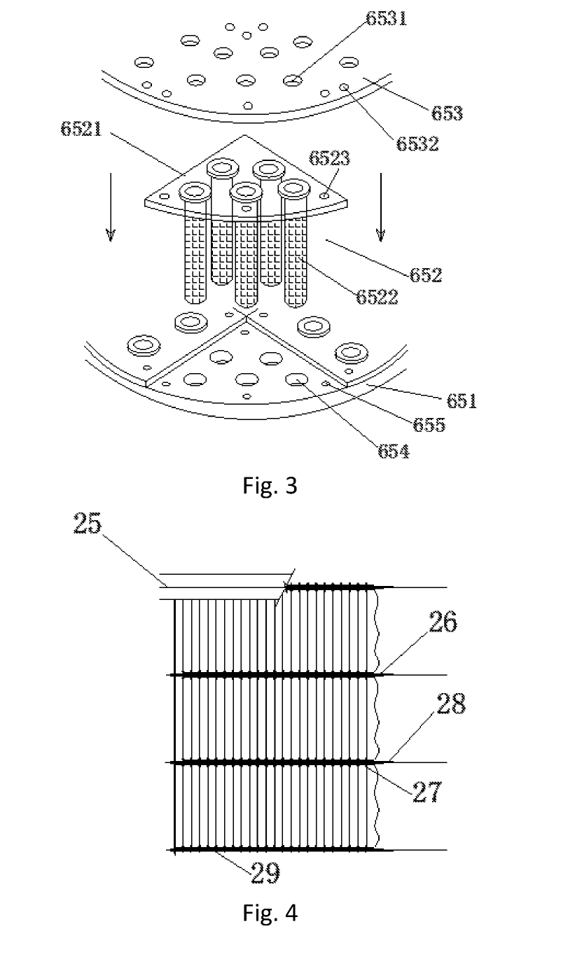

In an environmentally friendly balanced waste water treatment system for diversified medical use as shown in FIGS. 2 and 3, the membrane filter device 6 comprises a filter tank and a filter device 61 disposed inside the filter tank, the filter tank comprises an upper tank 62 and a lower tank 63. The upper tank 62 and the lower tank 63 are locked together through flange mouths. A raw water opening 621 is disposed at a top end of the upper tank 62 for connecting to the beveled wall sedimentation pool 5. A single filter plate 64 is connected between the upper tank 62 and the lower tank 63. A number of fine pores 641 and micropores 642 are uniformly distributed on the single filter plate 64. The lower tank 63 is divided into a backflow chamber 631 and a filter chamber 632, the fine pores 641 are connected to the backflow chamber 631, the micropores 642 are connected to the filter chamber 632. A sludge outlet 633 is disposed at a bottom of the backflow chamber 631 connected to the backflow pump 15. A filtered water outlet 634 is disposed at a side wall of the filter chamber 632 connected to the water pump 7. The filter device comprises a tubular membrane component 65 disposed inside the filtering chamber 632, the tubular membrane component 65 comprises a membrane support plate 651 horizontally fixed inside the filter chamber 632, a filter membrane module 652 and a pressed plate 653, the membrane support plate 651 is divided into four quarters, each quarter having five filter membrane insertion holes 654 and three alignment lock holes 655, openings 6531 corresponding to filter membrane insertion holes 654 and bolt holes 6532 corresponding to the alignment lock holes 655 are opened at the pressed plate 653. The filter membrane module 652 comprises a sub membrane support plate 6521 corresponding to a quarter of the membrane support plate 6521, and five tubular membrane components 6522 vertically mounted on the sub membrane support plate. An opening of the tubular membrane component 6522 penetrates through a top surface of the sub membrane support plate 6521. Through holes 6523 corresponding to the alignment lock holes 655 are disposed on the sub membrane support plate 6521. The pressed plate 653, the filter membrane module 6522 and the membrane support plate 651 are locked to the alignment lock hole 655 through the bolt hole 6532 and the through hole 6523.

In an environmentally friendly balanced waste water treatment system for diversified medical use as shown in FIG. 4, a suspended beam 25 is disposed inside the beveled wall sedimentation pool 5. A number of one sided beveled wall sheet 29 is attached to the suspended beam 25, a number of beveled wall horizontal rod 26 is disposed between adjacent suspended beams 25. A number of double sided beveled wall sheet 27 is disposed on the beveled wall horizontal rod 26, a reinforced pipe 28 is disposed inside a cavity of the beveled wall horizontal rod 26. The water treatment system can break down hazardous materials in the waste water, does not cause secondary pollution, provides a good cleaning effect for medical waste water, complying with water treatment standard. It provides improved practicality and advancement, operation is stable, does not occupy a lot of floor space, layout is reasonable, production efficiency is high, operating life is long, ensuring long trouble free operation time.

The environmentally friendly balanced waste water treatment system for diversified medical use, when in use, in one path waste water from medical washing cloth flows into the conditioning tank 1. The water in the conditioning tank 1 is then pumped to the beveled wall sedimentation pool 5 through the action of the waste water lifting pump 4. Through the action of the single sided beveled wall sheet 29 in the beveled wall sedimentation pool 5, the hazardous material in the waste water is broke down and sedimentated. Unfiltered water can also flow into the membrane filter device 6 through pipes, utilizing the single filter plate 64 inside the membrane filter device to pass large water molecules through the fine pores 641 into the backflow chamber 631 and pass small water molecules through the micropores 642 into the filter chamber 632. Water in the backflow chamber 631 is expelled as dirty water, water in the filter chamber 632 is filtered through the filter membrane module 652 in the tubular membrane component 65. The filter membrane module 652 can be replaced after filtering for a period of time, therefore is quick and convenient. Filtered water is poured into the clean water tank 8 through the action of water pump 7, and clean water is pumped into the cleaning solution tank 2 and the cleaning solution dosing tank 12 through the action of the cleaning lifting pump 11, rinsing the cleaning solution tank 2 and the cleaning solution dosing tank 12. Rinsed drug flows into the membrane filter device 6 for filtering, and utilizes the backflow pump 15 to pump the sedimentated waste water into the sludge tank 10. On the other hand, sludge is sedimentated to the bottom of the beveled wall sedimentation pool 5, and is removed by the sludge pump 9 to the sludge tank 10 and collected thereat. The sludge in the sludge tank 10 is poured into the additive trough 16 through the sludge pump, the additive trough 16 is mixed with the sludge conditioning trough 17 through the dosing tank 30. After a period of mixing inside the additive trough 16 and the sludge conditioning trough 17 by the mixer 23, the sludge is finally passed through to the centrifugal dehydration machine and is expelled in the form of harmless powder.

As revealed by the preferred embodiments of the present invention, based on the aforementioned description, a person skilled in the art can make various modifications and adjustments without departing from the technical concept of the present invention. The technical scope of the present invention is not limited to the specification but is defined by the scope of the claims.

What is claimed is:

1. An environmentally friendly balanced waste water treatment system for diversified medical use, comprises a conditioning tank, a cleaning solution tank, a gas separator, a waste water lifting pump, a beveled wall sedimentation pool and a membrane filter device; the conditioning tank is connected to an external washing cloth waste water pipe; the conditioning tank is connected to the air separator and the waste water lifting pump through pipes, an output end of the waste water lifting pump is connected to the beveled wall sedimentation pool through pipes; an electromagnetic flow gauge is disposed at a pipe connected between the waste water lifting pump and the beveled wall sedimentation pool; a side wall of the beveled wall sedimentation pool is connected to the filter membrane device through pipes; a water pump is connected at the filter membrane device, the filter membrane device is connected to a clean water tank through the water pump; a sludge pump is connected to a bottom of the beveled wall sedimentation pool through pipes; a sludge tank is connected at an output end of the sludge pump; a cleaning solution lifting pump is connected at the cleaning solution tank, a cleaning solution dosing pump is connected to the cleaning solution lifting pump through pipes; the cleaning solution dosing pump is connected separately to the filter membrane device, the clean water tank and the air separator; the air separator is connected to plant area gas pipes, a pressure reduction valve is disposed on the plant area gas pipes; another path of the air separator is connected to the filter membrane device through a vortex flow meter; a backflow pump is connected to a bottom end of the filter membrane device, the filter membrane device is connected to the sludge tank though the backflow pump; the sludge tank is connected to an additive trough through the sludge tank, the additive trough is connected to a sludge conditioning tank through a drug pump; the sludge conditioning trough is connected to a centrifugal dehydration machine;
the membrane filter device comprises a filter tank and a filter device disposed inside the filter tank, the filter tank comprises an upper tank and a lower tank; the upper tank and the lower tank are locked together through flange mouths; a raw water opening is disposed at a top end of the upper tank for connecting to the beveled wall sedimentation pool; a single filter plate is connected between the upper tank and the lower tank; a number of fine pores and micropores are uniformly distributed on the single filter plate; the lower tank is divided into a backflow chamber and a filter chamber, the fine pores are connected to the backflow chamber, the micropores are connected to the filter chamber; a sludge outlet is disposed at a bottom of the backflow chamber connected to the backflow pump; a filtered water outlet is disposed at a side wall of the filter chamber connected to the water pump; the filter device comprises a tubular membrane component disposed inside the filtering chamber, the tubular membrane component comprises a membrane support plate horizontally fixed inside the filter chamber, a filter membrane module and a pressed plate, the membrane support plate is divided into four quarters, each quarter having at least two filter membrane insertion holes and at least two alignment lock holes, openings corresponding to filter membrane insertion holes and bolt holes corresponding to the alignment lock holes are opened at the pressed plate; the filter membrane module comprises a sub membrane support plate corresponding to a quarter of the membrane support plate, and at least two tubular membrane components vertically mounted on the sub membrane support plate; an opening of the tubular membrane component penetrates through a top surface of the sub membrane support plate; through holes corresponding to the alignment lock holes are disposed on the sub membrane support plate; the pressed plate, the filter membrane module and the membrane support plate are locked to the alignment lock hole through the bolt hole and the through hole.

2. The environmentally friendly balanced waste water treatment system for diversified medical use according to claim 1, characterized in that: a pressure difference level meter is disposed in the conditioning tank.

3. The environmentally friendly balanced waste water treatment system for diversified medical use according to claim 1, characterized in that: mixers are disposed in the additive trough and the sludge conditioning trough; an ultrasonic level meter is disposed in the sludge conditioning trough.

4. The environmentally friendly balanced waste water treatment system for diversified medical use according to claim 1, characterized in that: a suspended beam is disposed inside the beveled wall sedimentation pool; a number of one sided beveled wall sheet is attached to the suspended beam, a number of beveled wall horizontal rod is disposed between adjacent suspended beams; a number of double sided beveled wall sheet is disposed on the beveled wall horizontal rod, a reinforced pipe is disposed inside a cavity of the beveled wall horizontal rod.
